(19) United States
(12) Patent Application Publication
(10) Pub. No.: US 2017/0031144 A1
(43) Pub. Date: Feb. 2, 2017

(54) Compact Side and Multi Angle Illumination Lensless Imager and Method of Operating the Same

(71) Applicant: ECOLE POLYTECHNIQUE FEDERALE DE LAUSANNE (EPFL), Lausanne (CH)

(72) Inventors: Manon Rostykus, Lausanne (CH); Christophe Moser, Lausanne (CH)

(21) Appl. No.: 15/219,315

(22) Filed: Jul. 26, 2016

Related U.S. Application Data
(60) Provisional application No. 62/198,158, filed on Jul. 29, 2015.

(51) Int. Cl. G02B 21/00; G02B 27/58; G02B 21/36; G02B 5/32; F21V 8/00; G02B 21/06; G02B 27/42

(52) U.S. Cl. CPC G02B 21/0056; G02B 21/06; G02B 27/58; G02B 27/4205; G02B 5/32; G02B 6/002; G02B 21/365

(57) ABSTRACT

A system for subpixel resolution imaging of an amplitude and quantitative phase image, the system including a waveguide having a top plane, a bottom plane, and two sides, an array of light sources emitting first befit beams from one side of the two sides of a waveguide, a holographic photopolymer film positioned on the top plane or the bottom plane of the waveguide and arranged to be illuminated by the first light beams from the array of light sources via the waveguide and to produce second light beams by diffraction, and an imaging device for capturing interference pattern light beams that passed through a sample, the sample arranged to be illuminated by the second light beams.

### CROSS-REFERENCE TO RELATED APPLICATIONS

The present patent application claims priority to U.S. provisional patent application No. 62/198,158 filed on Jul. 29, 2015, the entire contents thereof herewith incorporated by reference.

### FIELD OF THE INVENTION

The present invention relates to compact subpixel resolution lensless imagers, in particular, those systems that involve holography and multi angle illumination.

### BACKGROUND

Lensless imaging refers to an imaging technique which requires no imaging element between the light transmitted by the sample and the camera. A. Greenbaum, W. Luo, T. -W. Su, Z. Göröes, L. Xue, S. O. Isikman, A. F. Coskun, O. Mudanyali, and A. Ozcan, “imaging without lenses: achievements and remaining challenges of wide-field on-chip microscopy,” Nature Methods, vol. 9, no. 9 (2012). This configuration enables designing compact devices, First, it has been investigated for imaging in the Xray and UV spectral ranges because of the difficulty to produce lenses in that ranges. S, Eisebitt, J. Lüning, W. F. Schlotter, M. Lörgen, O. Hellwig, W. Eberhardt, and J, Stöhr, “Unless imaging, of magnetic nanostructures by X-ray spectro-holography,” Nature 432 (2004). In the visible range, it is mainly investigated for microscopy, because the high resolution (sub-micrometer) with large field of view equal to the size of the camera chip (˜cm²) is achievable. Moreover, it also has the advantage to be cost effective since microscope objectives are expensive and bulky.

The resolution of lensless devices is limited by the pixel size of the camera chip, usually several micrometers, and no more by the optics. To increase this resolution, several lensless techniques in microscopy have been proposed. Subpixel perspective sweeping microscopy uses images taken at several illumination angles. Between two illumination angles the shadows of the cells of the sample move of a subpixel distance. Then, a highly resolved image is reconstructed numerically. It is particularly interesting for sample with high confluence.

A resolution of 660 nm over a 24 mm² field of view has been reported with an on-chip device. G Zheng, S. A, Lee, Y. Antebi, M. B. Elowitz, and C. Yang, “The ePetri dish, an on-chip cell imaging platform based on subpixel perspective sweeping microscopy (SPSM),” PNAS, vol. 108, no. 41 (2011). However, this technique is limited by the fact that the cells have to be stained to obtain enough absorption of the light to create a shadow. Moreover, phase of the sample is not available and thus information about the 3-dimensional location of the cells is lost. Another way to increase the resolution is to use optofluidics. X. Cui, L. Man Lee, X. H. Weiwei Zhona, P. W. Sternberg, D. Psaltis, and C. Yang, “Lensless high-resolution on-chip optofluidic microscopes for Caenorhabditis elegans and cell imaging,” Proc. Natl. Acad. Sci. U.S.A. 105, 10670-10675 (2008) and G. Zheng, S. A. Lee, S. Yana, and C. Yang, “Sub-pixel resolving optofluidic microscope for on-chip cell imaging,” Lab Chip, 10 (2010). These publications used a flow of objects in a microfluidic channel with sub micrometer holes placed along the channel. Several projection images are taken, as the object moves with the flow, with a complementary metal oxide semi-conductor (CMOS) camera. Then, a highly resolved image is reconstructed numerically. A resolution of 750 nm has been reported.

Finally, digital inline holography has been investigated. It is a lensless interferometric technique which requires only one illumination beam. The beam goes through the sample, whose objects are the size of the illumination wavelength and which scatters part of the light. The other part of the light goes through unaffected. The scattered and unscattered fields are co-propagating and coherent with each other. They record an interferogram which is called an inline hologram. The images are then reconstructed numerically from the inline hologram, U. Schnars and W. Juptner, Digital holography (Springer, 2005). In order to increase the resolution, a multi angle illumination has been investigated, T. -W, Su, S. O. Isikaman, W. Bishara, D. Tseng, A. Edinger, and A. Ozcan, “Multi-angle lensless digital holography for depth resolved imaging on a chip,” Optics Express, 18, 9 (2010), and W. Luo, A. Greebaum, Y. Zheng, and A. Ozan, “Synthetic aperture-based on-chip microscopy,” Light: Science & Applications, 4 (2015). During this process the hologram is shifted by a distance inferior to the pixel size. Then a high resolution hologram is numerically reconstructed using the images taken with all the different angles. This technique has been proposed with incoherent illumination. O. Mudanyali, D. Tseng, C. Oh, S. O. Isikman, T, Sencan, W. Bishara, C. Oztoprak, S. Seo, B. Khademhosseine, and A. Ozcan, “Compact, light-weight and cost-effective microscope based on lensless incoherent holography for telemedicine applications,” Lab Chip, 10 (2010). This publication creates speckle free images, however, the compactness of the imager is then compromised because a rather large distance of several centimeters is needed between the source and the sample to obtain enough spatial coherence.

Accordingly, in light of the above-discussed deficiencies of the available solutions for lensless imaging and holographic imaging, further solutions are desired to overcome the problems encountered in the background art.

### SUMMARY

According to one aspect of the present invention, a system for subpixel resolution imaging of amplitude quantitative phase images is provided. The system preferably includes a waveguide having a top plane, a bottom plane, and two sides, an array of light sources emitting first light beams from one side of the two sides of a waveguide, and a holographic photopolymer film positioned on the top plane or the bottom plane of the waveguide and arranged to be illuminated by the first light beams from the array of light sources via the waveguide and to produce second light beams by diffraction. In addition, the system further preferably includes an imaging device for capturing interference pattern light beams that passed through a sample, a sample arranged to be illuminated by the second light beams.

According to another aspect of the present invention, a method is provided for operating a lensless subpixel resolution imaging device. Preferably, the device includes a waveguide having a top plane, a bottom plane, and two sides, an array of light sources emitting light beams from one side of the two sides of a waveguide, a holographic photopolymer film positioned on the top plane or the bottom plane of the waveguide and arranged to be illuminated by the light beams from the array of light sources via the waveguide and to produce diffracted light beams, a sample arranged to be illuminated by the diffracted light beams, and an imaging device for capturing interference pattern light beams from diffracted light beams that passed through the sample.

In addition, the method preferably includes the steps of turning on a light source from the array of light sources, such that a first light beam enters the prism and is diffracted by a multiplexed hologram grating included in the holographic photopolymer film, and recording a first hologram from a first diffracted light beam that passed the sample with the imaging device, and changing a current supplied to the light source from the array of light sources, such that a second light beam enters the prism and is diffracted by the multiplexed hologram grating, and recording a second hologram from a second diffracted light beam that passed the sample with the imaging device, the second hologram having a subpixel shift as compared to the first hologram.

The above and other objects, features and advantages of the present invention and the manner of realizing them will become more apparent, and the invention itself will best be understood from a study of the following description with reference to the attached drawings showing some preferred embodiments of the invention.

### BRIEF DESCRIPTION OF THE DRAWINGS

The accompanying drawings, which are incorporated herein and constitute part of this specification, illustrate the presently preferred embodiments of the invention, and together with the general description given above and the detailed description given below, serve to explain features of the invention, wherein

FIG. 1 is a side view schematic representation of an embodiment of the compact lensless imager device;

FIG. 2 is a side view schematic representation of an embodiment of the compact lensless imager with light paths for two vertical-cavity surface-emitting lasers (VCSELs);

FIG. 3 is a digital hologram taken with the device at one illumination direction with VCSEL as light source;

FIG. 4 is the digitally reconstructed amplitude of the hologram of FIG. 3;

FIG. 5 is a digital hologram taken with the device at one illumination direction with single frequency laser diode as light source;

FIG. 6 is the digitally reconstructed amplitude of the hologram of FIG. 5;

FIG. 7 is a side view schematic representation of an embodiment of the compact side illumination part during the multiplexing recording process of three hologram gratings into the photopolymer film;

FIG. 8 is a superposition of curves representing normalized diffraction efficiencies for three different angularly multiplexed hologram gratings versus the position of the source along the prism slanted side, as shown in FIG. 7; and

FIG. 9 is a top perspective view of a three dimensional representation to scale of an embodiment of the compact lensless imager connected to a consumer electronic device, such as a smart phone.

Herein, identical reference numerals are used, where possible, to designate identical elements that are common to the figures. Also, the images are simplified for illustration purposes and may not be depicted to scale.

### DETAILED DESCRIPTION

According to one aspect of the present invention, a device or system is provided having a compact multi angle illumination lensless imager having a side illumination whet than top illumination to decrease the vertical dimension of the imager. The device comprises of an array of light sources, each light source in the array emitting a single mode spatial profile and disposed onto the side of a guiding flat structure, such as, but not limited to, a waveguide and a holographic material into which multiplexed hologram gratings are recorded and which generates the appropriate illumination angle depending on the position of the illumination laser source. This device or system allows for weakly light absorbing samples, but not limited to, to be imaged with subpixel resolution. The amplitude and phase images of a sample can be digitally retrieved. The following description of the imager is intended to give, by way of example, the physical dimension and the component selection as an exemplary embodiment. However, it should not be treated as being restrictive. The device or system first includes a Dove prism as the waveguide, or an assembly of prisms, with, but not limited to, an entrance surface of 5 mm×5 mm, a longest side length of 21.1 mm and two 45° cut sides.

An array of single mode spatial light sources, such as but not limited to, VCSELs placed at approximately a few millimeters, away from one slanted side of the prism. One VCSEL chip can be a square chip of 250 μm side, but not limited to. One VCSELs array is positioned at the slanted side of the prism. In at least one embodiment, a compact side illumination system is provided. A photopolymer film can be laminated on one side of the prism, but not limited to this variant. Several analog hologram gratings can be first recorded or otherwise provided in the photopolymer. The recording process of angular multiplexed hologram gratings follows the background art. For example, holographic photopolymers such as Bayfol® HX polymer, dichromated gelating, phenanthrenquinone-doped poly(methyl methacrylate) (PO-PMMA), or Dupont polymer can be used. See for example H. Berneth, F. -K. Bruder. T. Fäcke, R. Hagen, D. Hönel, D. Jurbergs, T. Rölle, and M. -S. Weiser, “Holographic recording aspects of high-resolution Bayfol® HX photopolymer”, Proc. Of SPIE vol. 7957, 79570H, T. A. Shankoff, “Phase holograms in dichromated gelatin”, Applied Optics, vol. 7, no. 10 (1968), Y. Luo, P. I Gelsinger, J. K. Barton, G. Barbastathis, and R. K. Kostuk, “Optimization of multiplexed holographic gratings in PQ-PMMA for spectral-spatial imaging filters”, Optics Express, vol. 33, no. 6 (2008), and U. -S, Rhee, H. J. Caulfield, C. S. Vikram, and J. Shamir, “Dynamics of hologram recording in DuPont photopolymer”, Applied Optics, vol. 34, no. 5 (1995).

In at least one embodiment, for each VCSEL light source positioned at the side of the prism there is a corresponding analogic hologram grating with a specific diffraction direction, the analogic hologram fixating provided by the photopolymer film or layer. In at least one embodiment, the number of gratings recorded in the photopolymer can be equal to the number of VCSELs in the arrays. The light diffracted by the gratings illuminates the sample to be imaged. The transmitted interference pattern, that is caused the diffracted light traversing the sample, is an inline hologram, and these inline holograms can be captured as images by an imaging device or camera.

VCSELs can be turned on sequentially, but not limited to, and one Milne digital hologram is recorded for each VCSEL, which means for each illumination direction, but not limited to. Moreover, a shift of VCSEL wavelength can be performed by changing the driving current or temperature of the VCSEL. This wavelength Shift results in an angular change of the diffracted beam by the hologram grating which consequently results in a lateral shift of the inline hologram which can be, but not limited to, of subpixel distance in reference to the image sensor plane of the camera or imagine device. Then, all digital holograms are combined in a reconstruction algorithm such as pixel super resolution, synthetic aperture-based phase retrieval algorithms. See W. Luo, A. Greebaum, Y. Zheng, and A, Ozcan, “Synthetic aperture-based on-chip microscopy,” Light: Science & Applications, 4 (2015). In a variant, the Fourier ptychography algorithm can be used. G. Zheng, R. Horstmeyer, and C. Yang, “Wide-field, high-resolution Fourier ptychographic microscopy,” Nature Photonics, vol. 7 (2013).

Further, in at least one embodiment of the present invention, it is possible to battery-operate the device or system because VCSELs are low power consumption lasers. This allows the device or system to be highly mobile, and can make it compatible for portable operations together with standard and readily-available consumer electronic devices, such as smart phones. The techniques, apparatus, materials and systems as described in this specification are used to implement a compact subpixel resolution lensless imager.

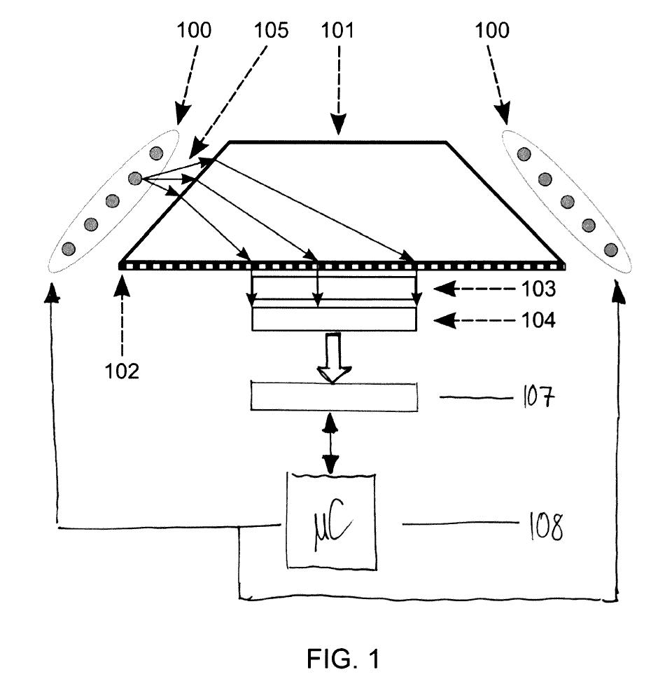

Described is a compact side and multi angle illumination lensless imager composed of a waveguide, arrays of spatially single mode VCSELs, but not limited to, a holographic photopolymer film, and an imaging device or camera. FIG. 1 shows a depiction of a side view schematic representation of one embodiment of the imager and describes the light path from one emitting VCSEL towards the image sensor of the camera or imaging device 104. The light path coining from one VCSEL in the left side array 100 is shown with arrows 105. The beam enters the Dove prism 101 through one slanted side and is diffracted by the multiplexed hologram gratings recorded in the photopolymer layer 102. Then it goes through the sample 103 and the generated inline hologram is recorded on the camera or imaging device 104. Imaging device includes a two-dimensional image sensor having a certain pixel resolution with a certain pixel size. The imaging device 104 can then provide the captured image to a data processing device 107, for example a microprocessor with memory, to process the data of the captured images from the imaging device 104. For example, the processing device 107 can he configured to process and store image data, and perform image data processing algorithms, for a reconstruction algorithm to create an amplitude and quantitative phase images from the sample with subpixel resolution.

Moreover, a controller 108 is arranged that is configured to control the system, for example the light beams and the settings of the light beams of the individual light sources of the array of lights 100. Also, the controller 108 can control the image capture process by imaging device 104 and data processing device 107, for example to set specific illumination settings with the array of lights 100 before triggering an image capture with imaging device 107.

According to another aspect of the present invention, a method for capturing a digital hologram is presented. The method to capture and record the digital holograms can be as follows, but not limited to, the following steps. First, One VCSEL is turned on, and the light emitted by the VCSEL enters the Dove prism. Next, the light that has passed through the Dove prism is then diffracted by one of the multiplexed hologram grating recorded in the photopolymer film. Next, the diffracted beam illuminates the sample, and the inline hologram is recorded by the camera or imaging device. Thereafter, the driving current of the VCSEL is changed, to obtain subpixel shifts of the inline hologram in the camera plane. For each value of the driving current, a new digital hologram is recorded by the camera Or imaging device. These steps of the method can be controlled by the controller 108 that can in turn control operation of the array of lights 100, for example an array of VCSEL lights, the data processing device 107, and the imaging device 104.

This method or process is reiterated for each VCSEL, one at a time, but not limited to. For each VCSEL corresponds an analog hologram grating, but not limited to, which results in different illumination directions on the sample. The result is a stack of inline digital holograms of the sample taken with different illumination directions. This stack is then introduced as input of a reconstruction algorithm. The output of the algorithm is the amplitude and the quantitative phase images of the sample with subpixel resolution.

FIG. 7 show a schematic representation of a method to record different hologram gratings into the photopolymer layer or film 706. For example, the beam from s first source position 700 interferes with a first beam 703 in the photopolymer 706. The interference pattern of these two beams 700, 703 is recorded in the photopolymer. This interference pattern is an analog phase hologram grating. The same process is done sequentially for the beam from a second source position 701 interfering with the second beam 704, and the beam from the third source position 702 interfering with the third beam 705. The recording of these three different gratings is done sequentially. FIG. 7 shows the recording process of three angularly multiplexed hologram gratings in the photopolymer film 706 laminated on the Dove prism. A continuous-wave, single frequency laser is collimated and split by a beam splitter to generate, but not limited to, a plane wave signal beam and a high numerical aperture spherical reference beam. The reference beams of the first, second, and third source positions 700, 701, 702 and the first, second, and third beams 703, 704, 705, respectively, interfere in the photopolymer inducing index of refraction changes, which result in a phase grating. The angle of the signal beam with respect to the normal to the prism is controlled with a two-dimensional (2D) scanning system.

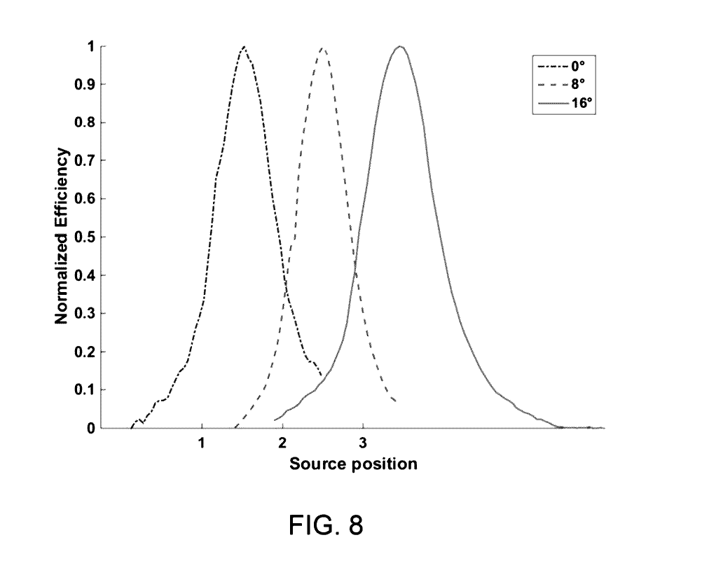

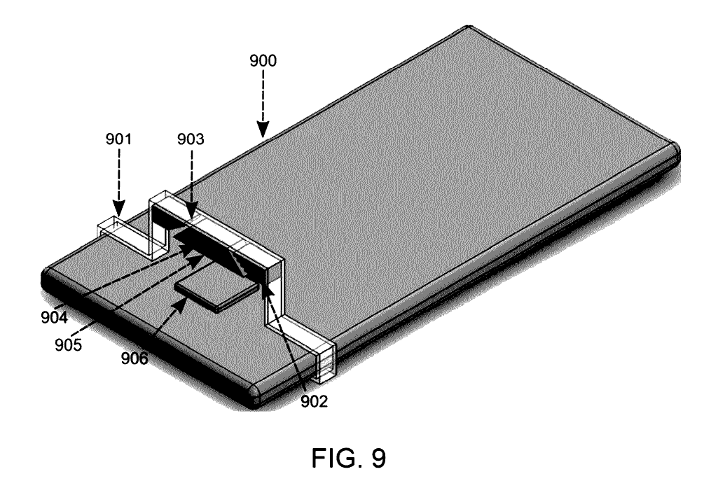

FIG. 8 is a Superposition of curves representing normalized diffraction efficiencies for three different angularly multiplexed hologram gratings versus the position of the source along the prism slanted side, as shown in FIG. 7. The indicated angles in the legend correspond to the diffraction output angles of the beam with respect to the normal to the prism surface where the photopolymer is laminated. The recording experiment is represented in FIG. 7.

As a proof of principle and to perform tests and measurements, a continuous wave red laser was set in a Mach-Zender interferometer configuration to record five angularly multiplexed hologram gratings in a 50 μm thick photopolymer film laminated on a N-BK7 Dove prism with an entrance surface of 5 mm×5 mm, a longest side length of 21.1 mm and two 45° cut sides. Each hologram grating was recorded with a different position of the reference beam along the prism entrance slanted side. Between two positions a constant distance of 800 μm was set. For each hologram, the direction of the signal beam with respect to the normal to the prism longest side surface in the plane of the prism was also different. Angles of 0°, 8°, 16°, 24° and 32° were chosen. Diffraction efficiencies between 0.12% and 0.22% were measured. The zero order (>99%) is reflected out of the prism by total internal reflection.

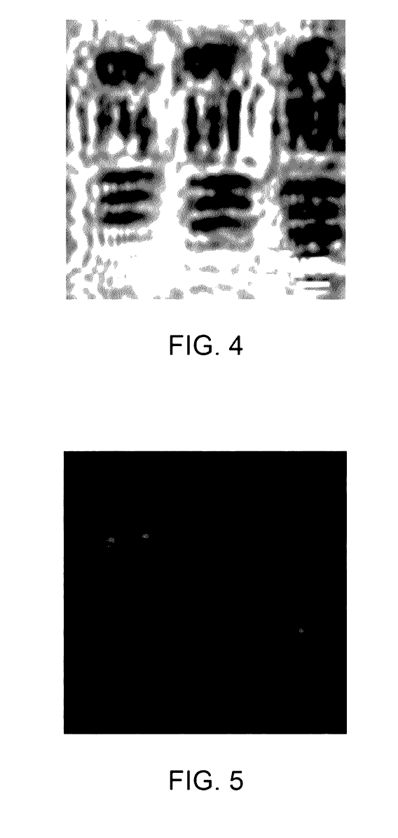

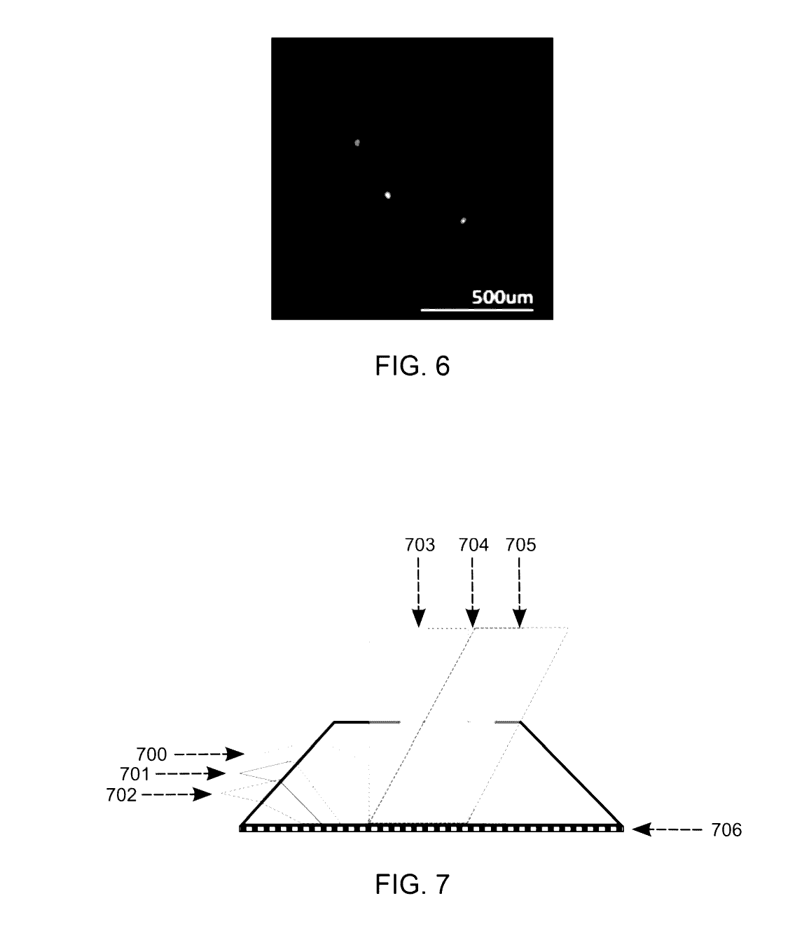

A digital hologram of a USAF 1951 resolution test chart with resolution test patterns was recorded with a normal illumination as shown in FIG. 3 with the device with VCSEL light source and its amplitude was reconstructed, as shown in FIG. 4. The distance between the sample and the camera sensor was of 1.9 mm. A digital hologram of ø60 μm polystyrene beads on a microscope slide was recorded with a normal illumination as shown in FIG. 5 with the device with a single frequency laser diode light source and its amplitude was reconstructed, as shown in FIG. 6. The distance between the sample and the camera sensor was of 9.5 mm.

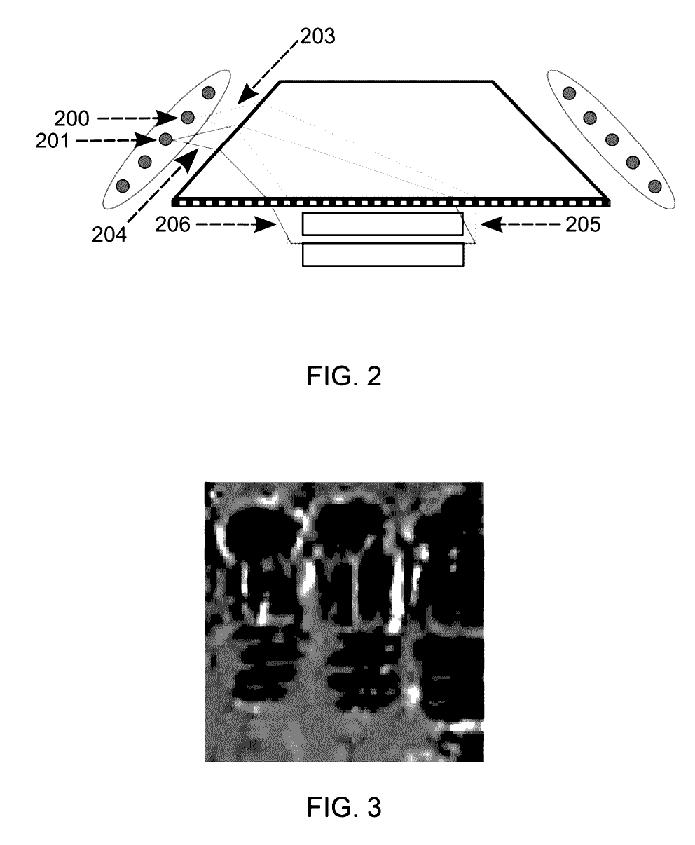

FIG. 2 is a top view drawing of another embodiment of the compact lensless imager with light paths for two VCSELs. The light paths coming from two VCSELs 200, 201 in the left side array are shown 203, 204, Diffracted beams 205, 206 are generated by the multiplexed hologram gratings.

FIG. 9 is a top-side perspective view of a three-dimensional representation to scale at an embodiment of the compact lensless imager connected to an electronic device, for example but not limited to a smart phone. The prism 904 onto which the photopolymer film is laminated and the holders, one is shown with reference numeral 902, of the light sources, one shown with reference numeral 903 are held with folded bar 901 to a consumer electronic device, for example but not limited to smart phone 900. in this embodiment the camera chip 906 of the smart phone 900 is used to record the digital inline holograms.

While the invention has been disclosed with reference to certain preferred embodiments, numerous modifications, alterations, and changes to the described embodiments, and equivalents thereof, are possible without departing from the sphere and scope of the invention. Accordingly, it is intended that the invention not be limited to the described embodiments, and be given the broadest reasonable interpretation in accordance with the language of the appended claims.

1. A system for subpixel resolution imaging of an amplitude and quantitative phase image, the system comprising:
a waveguide having a top plane, a bottom plane, and two sides;
an array of light sources emitting first light beams from one side of the two sides of a waveguide;
a holographic photopolymer film positioned on the top plane or the bottom plane of the waveguide and arranged to be illuminated by the first light beams from the array of light sources via the waveguide and to produce second light beams by diffraction; and
an imaging device for capturing interference pattern light beams that passed through a sample, the sample arranged to be illuminated by the second light beams.

2. The system of claim 1, wherein each light source of the array of light sources generate light that is spatially single mode, the light source including at least one of a vertical-cavity surface-emitting laser (VCSEL), a laser diode, a super luminescent light emitting diode (SLED), a light emitting diode, and a quantum dot.

3. The system of claim 1, wherein the waveguide includes a Dove prism, an array of Dove prism, or a rectangular waveguide.

4. The system of claim 1, wherein the first light beams are reflected by total internal reflection of the waveguide away from the imaging device.

5. The system of claim 1, wherein the second light beams are directed towards the sample and the imaging device.

6. The system of claim 1, wherein the holographic photopolymer film includes a single color or panchromatic film.

7. The system of claim 1, wherein the holographic photopolymer film includes multiplexed holograms.

8. The system of claim 3, wherein the holographic photopolymer film includes a plurality of inline holograms, each of the inline holograms providing for different illumination directions of the sample by diffraction from the holographic photopolymer film.

9. The system of claim 1, wherein the array of light sources are positioned along the two sides of the waveguide, the sides of the waveguide being slanted.

10. The system of claim 1, wherein the sample is arranged between the prism and the imaging device.

11. The system of claim 1, wherein the interference pattern light beams captured by the imaging device include a plurality of inline digital holograms, the inline digital holograms being subpixel shifted relative to pixels of the imaging device by tuning a driving current of the array of the light sources.

12. The system of claim 1, further comprising:
a digital image processing device arranged to digitally process images produced by the imaging device, in order to retrieve an amplitude image and a quantitative phase image of the sample with subpixel resolution.

13. The system of claim 1, further comprising:
a battery arranged to power an operation of the system.

14. The system of claim 1, further comprising:
an attachment mechanism for attaching the system to a connected consumer electronic device.

15. A method for operating a lensless subpixel resolution imaging device, the device including,
a waveguide having a top plane, a bottom plane, and two sides, an array of light sources emitting light beams from one side of the two sides of a waveguide, a holographic photopolymer film positioned on the top plane or the bottom plane of the waveguide and arranged to be illuminated by the light beams from the array of light sources via the waveguide and to produce diffracted light beams, a sample arranged to be illuminated by the diffracted light beams, and an imaging device for capturing interference pattern light beams from diffracted light beams that passed through the sample, the method comprising the steps of:
turning on a light source from the array of light sources, such that a first light beam enters the prism and is diffracted by a multiplexed hologram grating included in the holographic photopolymer film, and recording a first hologram from a first diffracted light beam that passed the sample with the imaging device; and
changing a current supplied to the light source from the array of light sources, such that a second light beam enters the prism and is diffracted by the multiplexed hologram grating, and recording a second hologram from a second diffracted light beam that passed the sample with the imaging device, the second hologram having a subpixel shift as compared to the first hologram.
